(19) United States
(12) Patent Application Publication
(10) Pub. No.: US 2011/0119950 A1
(43) Pub. Date: May 26, 2011

(54) PUDDLE ELIMINATING SYSTEM AND PUDDLE ELIMINATING METHOD

(75) Inventors: Yu-Lun Ho, Taipei County (TW); Chin-Chi Hsiao, Taoyuan County (TW); Chia-Pin Kuo, Tainan County (TW); Wei-Han Wang, Taipei City (TW)

(73) Assignee: INDUSTRIAL TECHNOLOGY RESEARCH INSTITUTE, Hsinchu (TW)

(21) Appl. No.: 12/703,203

(22) Filed: Feb. 10, 2010

(30) Foreign Application Priority Data
Nov. 25, 2009 (TW) 98140207

(51) Int. Cl. F26B 5/12

(52) U.S. Cl. 34/397; 34/92

(57) ABSTRACT

A puddle eliminating system and a puddle eliminating method are provided. The puddle eliminating system includes a main body, a moving wheel set, a water absorbing unit, at least one water sensor, a water-storage tank and a fan unit. The main body has a control unit, which the moving wheel set disposed at the bottom of the main body and the fan unit are electrically connected to. The water absorbing unit having the water sensor therein and being electrically connected to the control unit is disposed at the main body. The water-storage tank communicates with the water absorbing unit. The moving wheel set shifts and the absorbing unit absorbs and transmits puddle to the water-storage tank. The water sensor detects in a predetermined period whether there is puddle in an environment whereat the puddle eliminating system is placed or not and transmits detecting signals to the control unit.

### CROSS-REFERENCE TO RELATED APPLICATION

This application claims the priority benefit of Taiwan application serial no. 98140207, filed on Nov. 25, 2009. The entirety of the above-mentioned patent application is hereby incorporated by reference herein and made a part of specification.

### BACKGROUND OF THE INVENTION

1. Field of the Invention

The disclosure relates to a puddle eliminating system and a puddle eliminating method.

2. Description of Related Art

Sweeping the ground of an indoor environment is the most routine work of daily cleaning. Many kinds of clean machines with convenience have invented for easing load of human beings. Take common dust collecting fans for collecting dust and dust collecting fans for sweeping the ground and absorbing puddle as examples, the clean machines are developed to have abilities of sweeping automatically and eliminating puddle.

According to a research, puddle is often formed in a bathroom or a lavatory in a house, where the elders fall down mostly. Take the most advanced cleaning robot for wet and dry cleaning as an example, the robot can't judge whether puddle on the ground is cleaned up or not on its own, thus the robot still keeps eliminating after puddle on the ground has been cleaned up until power electricity is exhaust. As such, power electricity is wasted, much noise is generated, and the robot works in vain such that work efficiency is affected.

Besides, working period of available cleaning robots is limited by the capacity and lifespan of cells, thus if the cleaning robot is placed in an environment with larger range, the cleaning robot does not have enough power electricity for completing the cleaning mission.

FIG. 1 is a perspective view of a conventional cleaning robot for wet and dry cleaning. With reference to FIG. 1, the cleaning robot 100 sweeps and absorbs dust and scraps in the first when on duty, then sprays and washes the ground, and finally gathers and absorbs sewage into the recycle bag by spiral clumps at bottom of the robot, such that the ground is cleaned up. The cleaning robot 100 shifts automatically and the shifting path varies with different commands. The cleaning robot 100 has abilities of not only collecting dust but also washing the ground and making the ground clean and dry. However, the cleaning robot 100 itself cannot judge when to stop cleaning, that is to say the cleaning robot 100 works until the working period preset is due or power electricity is exhaust. Further, cells configured in the cleaning robot 100 are limited by the integral size of the cleaning robot 100, electricity capacity of cells are also limited; therefore when the cleaning robot 100 does not have enough power electricity for completing the cleaning mission when working in a larger working area.

FIG. 2 is a perspective view of another one conventional cleaning robot for wet and dry cleaning. With reference to FIG. 2, the cleaning robot 200 also has abilities of sweeping automatically and eliminating puddle, and the fan disposed therein rotates such suction is formed therefore dust and sewage around are absorbed into a specific storage-tank. Further, a rinsing-tank disposed therein sprays cleaning agent for washing dirty ground. In the puddle eliminating mold of the cleaning robot 200, sewage on the ground is absorbed by an absorbent opening 214 and transferred to a gathering tank 220 at top by a built-in pipe 250, wherein a sucker 252 of the cleaning robot 200 is shaped in rectangle with narrow length and broad width for eliminating puddle on the ground with large area. Though the cleaning robot 200 has abilities of wet and dry cleaning, it means that the cleaning robot 200 collects dust and eliminates puddle on the ground at the same time, but the cleaning robot 200 cannot shift automatically.

FIG. 3 is a perspective view of still another one conventional cleaning robot. With reference to FIG. 3, the cleaning robot 300 is used for washing ground. It sprays water or cleaning agent of a cistern 314 to wet the ground, and the absorbing unit 333 absorbs sewage back into a cistern 327, and then a drying apparatus is used for drying the ground by heat, thus the cleaning mission is completed. A rotating clump 323 and a water-spray-opening 331 is disposed at a bottom of the cleaning robot 300 for washing the ground. A sucker 332 disposed at a front side of the cleaning robot 300 absorbs sewage to the cistern 327, and the drying apparatus blow hot winds for drying the ground. The cleaning robot 300 has abilities of washing the ground and eliminating puddle, but a user is needed for manipulating it.

FIG. 4 is a perspective view of the other conventional cleaning robot. With reference to FIG. 4, the cleaning robot 400 is automatically shifting. The cleaning robot 400 includes at least three parts described as follows: a cleaning head module 420, a hose assembly 430 and a canister module 410. The canister module 410 has a controller used for controlling the cleaning robot 400 to shift and clean. The cleaning head module 420 and the canister module 410 of the cleaning robot 400 both have wheels for shifting. A difference between the cleaning robot 400 and the related cleaning robot 100, 200, 300 mentioned above is that the cleaning head module 420 and the canister module 410 are separated. However, the cleaning robot 400 executes the sweeping mission according to the preset period set by the user or until power electricity is exhaust.

### SUMMARY OF THE INVENTION

The disclosure is directed to a puddle eliminating system which is automatically shifting and effectively eliminating puddle on the ground.

The disclosure is directed to a puddle eliminating method for improving operation efficiency of a robot.

The disclosure is directed to a puddle eliminating system including a main body, a moving wheel set, a water absorbing unit, at least one water sensor, a water-storage tank and a fan unit. The main body has a control unit, and the moving wheel set is disposed at a bottom of the main body and electrically connected to the control unit. The water absorbing unit is disposed in the main body and used for eliminating puddle in an environment whereat the puddle eliminating system is placed. The water sensor is disposed in the water absorbing unit and electrically connected to the control unit. The water sensor is used for detecting whether puddle passes through the water absorbing unit. The water-storage tank communicates with the water absorbing unit for storing puddle absorbed by the water absorbing unit. The fan unit is electrically connected to the control unit. The control unit drives the moving wheel set to shift and controls the fan unit to provide suction, such that the water absorbing unit absorbs and transfers puddle into the water-storage tank, and the water sensor detects whether there is puddle in the environment whereat the puddle eliminating system is placed in a predetermined period and transfers detecting signals to the control unit.

The disclosure is further directed to a puddle eliminating method, includes at least the following steps: providing a puddle eliminating system, wherein a moving wheel set of the puddle eliminating system brings the puddle eliminating system to shift in a predetermined environment; at least one water sensor of the puddle eliminating system detects whether a water absorbing unit of the puddle eliminating system absorbs puddle or not; when the at least one water sensor detects that the water absorbing unit has absorbed puddle, the at least one water sensor transfers a keep-eliminating-signal to a control unit of the puddle eliminating system, and the puddle eliminating system keeps eliminating puddle; when the at least one water sensor detects that the water absorbing unit has absorbed no puddle in a detecting period, the at least one water sensor transfers a stop-eliminating-signal to the control unit, and the puddle eliminating system stops eliminating puddle, wherein the detecting period is greater than a predetermined period.

As mentioned above, the puddle eliminating system and the puddle eliminating method thereof automatically detect whether puddle is eliminated or not. When puddle is eliminated completely, the eliminating mission is stopped automatically. As such, the puddle eliminating system is prevented fo an idle running, and operation time and power electricity are also saved.

It is to be understood that both the foregoing general descriptions and the following detailed embodiments are exemplary and are, together with the accompanying drawings, intended to provide further explanation of technical features and advantages of the disclosure.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of a conventional cleaning robot for wet and dry cleaning.

FIG. 2 is a perspective view of another one conventional cleaning robot for wet and dry cleaning.

FIG. 3 is a perspective view of still another one conventional cleaning robot.

FIG. 4 is a perspective view of the other conventional cleaning robot.

FIG. 5A is a perspective view illustrating a puddle eliminating system of the first embodiment in the present invention.

FIG. 5B is an enlarged view illustrating a part of the water absorbing unit in

FIG. 5A.

FIG. 5C is a perspective view illustrating the dispositions of the water sensors in the water absorbing unit.

FIG. 6 is a flow chart illustrating a method using the puddle eliminating system in FIG. 5A for eliminating puddle.

FIG. 7 is a perspective view illustrating the puddle eliminating system and a predetermined shifting path thereof that the puddle eliminating system shifts in a predetermined environment.

FIG. 8A is a perspective view illustrating the water absorbing unit and the water sensor of the puddle eliminating system of the second embodiment in the present invention.

FIG. 8B is a perspective view illustrating another way of disposing the water sensor in the water absorbing unit in FIG. 8A.

FIG. 9 illustrates the state of puddle on the ground or a datum plane whereat the puddle eliminating system is placed.

FIG. 10 is a flow chart illustrating another method of using the puddle eliminating system in FIG. 5A for eliminating puddle.

FIGS. 11A and 11B illustrate a shifting path of the puddle eliminating system using the puddle eliminating method.

FIG. 12 is a diagram of a command set saved in the control unit.

FIG. 13 is a perspective view illustrating the puddle eliminating system of the fourth embodiment in the present invention.

FIG. 14 is a perspective diagrammatical view illustrating the puddle eliminating system of the fifth embodiment in the present invention.

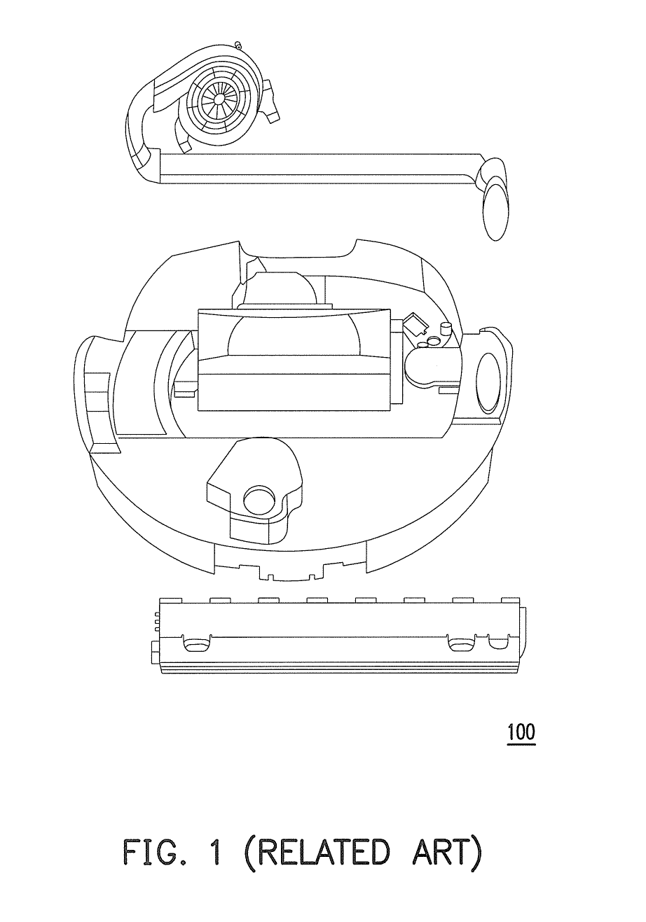

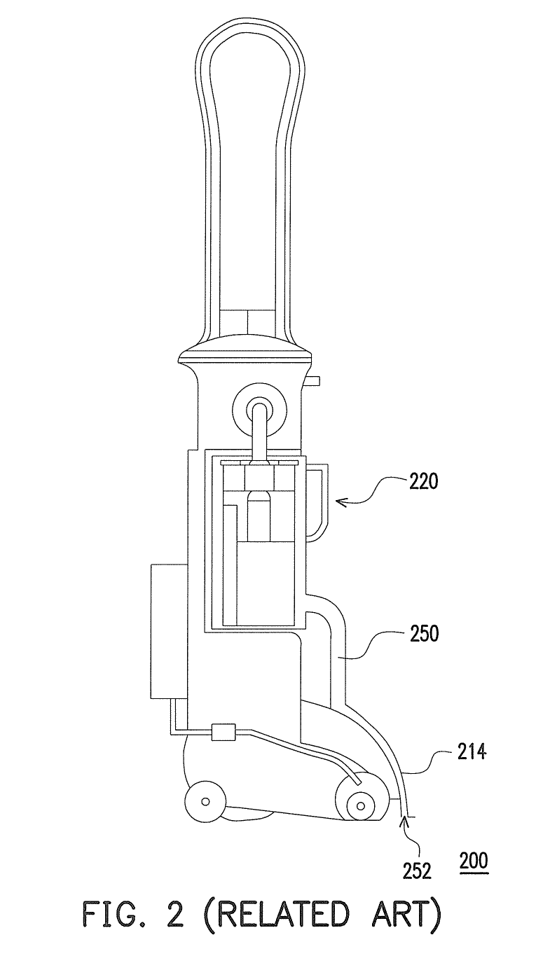

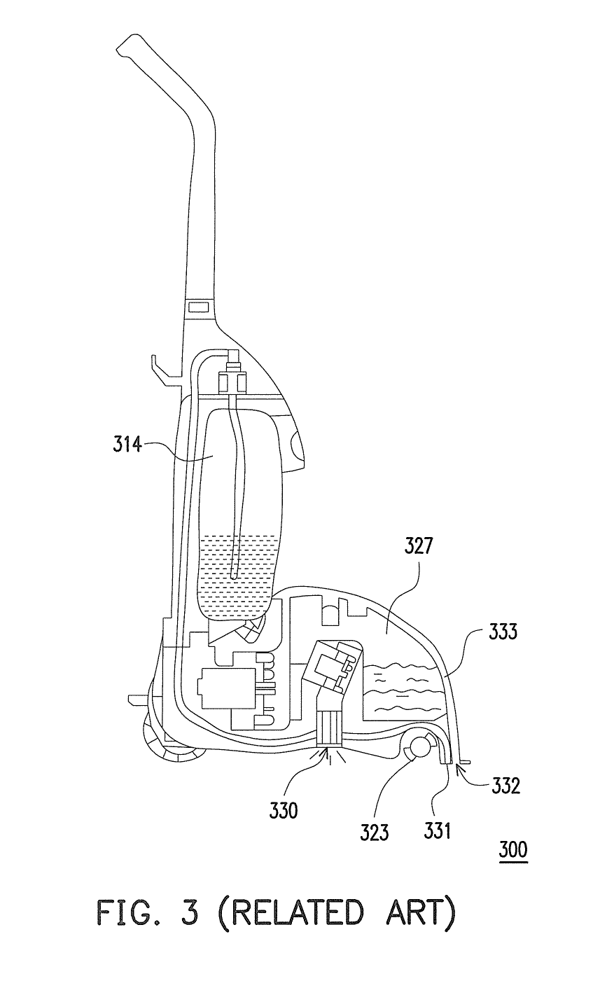

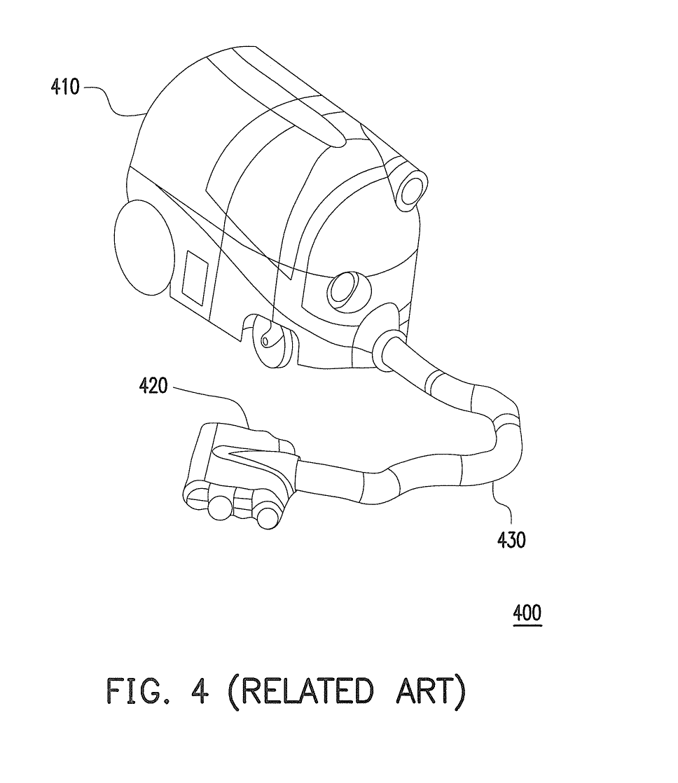

### DESCRIPTION OF EMBODIMENTS

### First Embodiment

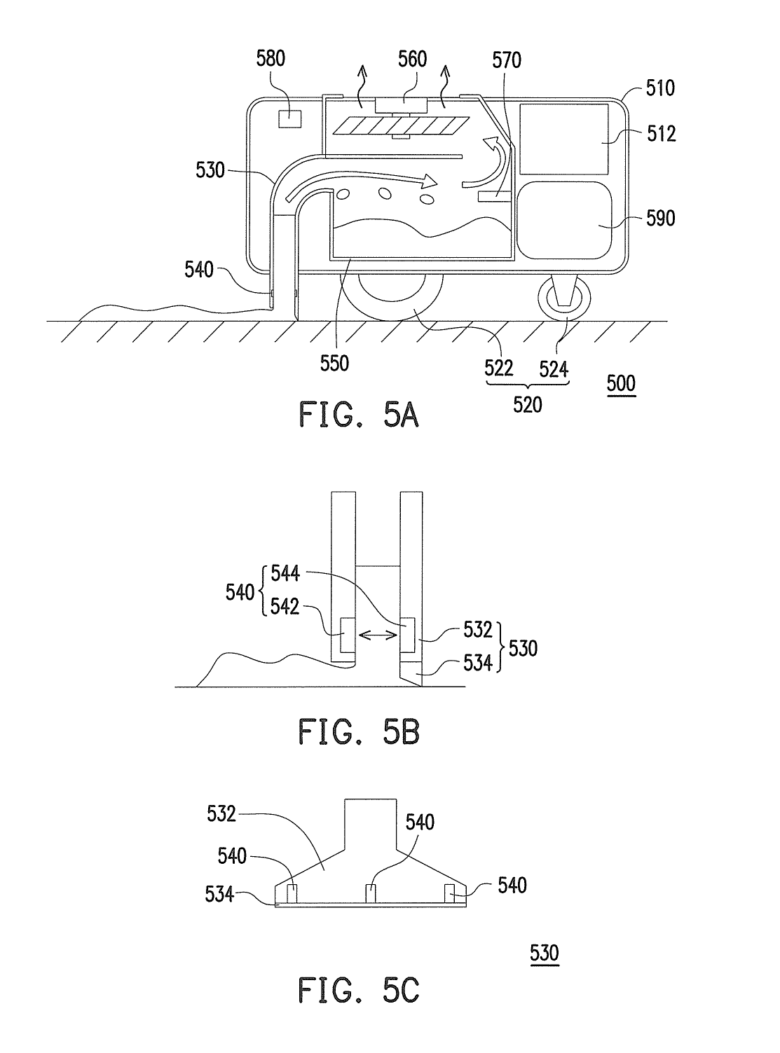

FIG. 5A is a perspective view illustrating a puddle eliminating system of the first embodiment in the present invention. With reference to FIG. 5A, the puddle eliminating system 500 includes a main body 510, a moving wheel set 520, a water absorbing unit 530, at least one water sensor 540, a water-storage tank 550 and a fan unit 560. The main body 510 has a control unit 512, the moving wheel set 520 is disposed at the bottom of the main body 510, and the moving wheel set 520 is electrically connected to and driven by the control unit 512 to carry the main body 510 to move. The water absorbing unit 530 is disposed in the main body 510 for eliminating puddle on the ground or a datum plane in an environment whereat the puddle eliminating system 500 is placed. The water sensor 540 is disposed in the water absorbing unit 530 and electrically connected to the control unit 512. The water sensor 540 is used for detecting whether puddle passes through the water absorbing unit 530 or not and transfers detecting signals to the control unit 512, such that the puddle eliminating system 500 keeps or stops the eliminating mission. The water-storage tank 550 communicates with the water absorbing unit 530 for storing puddle absorbed by the water absorbing unit 530. The fan unit 560 is electrically connected to the control unit 512.

In the embodiment, the water-storage tank 550 and the fan unit 560 are both disposed in the main body 510. Furthermore, the moving wheel set 520 is a combination of being selected two from a orientation wheel, a universal wheel, an omnidirectional wheel, a caterpillar band and a chain, and the two of the combination are respectively at opposite sides of the bottom of the main body 510. In this embodiment, the orientation wheel 522 and the universal wheel 524 are selected to be configured as the moving wheel set 520, wherein the orientation wheel 522 is disposed at the front side of the bottom, and the universal wheel 524 is disposed at the rear side of the bottom, and the universal wheel 524 followed the control signal of the control unit 512 shifts around and drives the orientation wheel 522 to move, such that the puddle eliminating system 500 shifts around non-orientatedly. Here, positions whereat the orientation wheel 522 and the universal wheel 524 disposed may be exchanged according to actual requirements. The water absorbing unit 530 is disposed at the front side of the main body 510, and the orientation wheel 522 is located between the water absorbing unit 530 and the universal wheel 524. Disposing the water absorbing unit 530 in the front side of the main body 510, puddle can be eliminated by the water absorbing unit 530 before the moving wheel set 520 contacts puddle, and therefore the moving wheel set 520 is prevented from slipping.

FIG. 5B is an enlarged view illustrating a part of the water absorbing unit in FIG. 5A. Referring to FIGS. 5A and 5B, the water absorbing unit 530 mentioned above includes a pipe 532 and a windshield wiper 534. The pipe 532 is flat and connected to the main body 510 and communicates with the water-storage tank 550 disposed in the main body 510. The windshield wiper 534 is disposed at the rear side of the pipe 532, and the windshield wiper 534 contacts the ground or the datum plane in the environment whereat the puddle eliminating system 500 is placed. When the pipe 532 of the water absorbing unit 530 is absorbing puddle, the windshield wiper 534 scrapes puddle on the ground or the datum plane conveniently with the shifting of the puddle eliminating system 500, and therefore the effect of eliminating puddle is improved. FIG. 5C is a perspective view illustrating the dispositions of the water sensors in the water absorbing unit. Referring to FIGS. 5A, 5B and 5C, there are three water sensors 540 in this embodiment, and all are disposed at appropriate position of the flat pipe 532 according to actual requirements. The water sensor 540 is a resistiveness sensor having a first electrode 542 and a second electrode 544, and the first electrode 542 and the second electrode 544 are disposed at opposite sides in the pipe 532.

With reference to FIG. 5A, the puddle eliminating system 500 further comprises a water level sensor 570 disposed in the water-storage tank 550 for detecting a water level in the water-storage tank 550. In addition, the puddle eliminating system 500 further comprises a roadblock sensor unit 580 disposed at the main body 510 for detecting roadblocks in the shifting process of the main body 510, wherein the roadblock sensor unit 580 is a ultrared-ray sensor, a ultrasonic sensor, a laser sensor or a combination thereof, according to actual requirements. Further, the puddle eliminating system 500 further comprises a power supply module 590 electrically connected to the control unit 512 of the main body 510, and the power supply module 590 is disposed in the main body 510 for providing power electricity to the puddle eliminating system 500 for shifting.

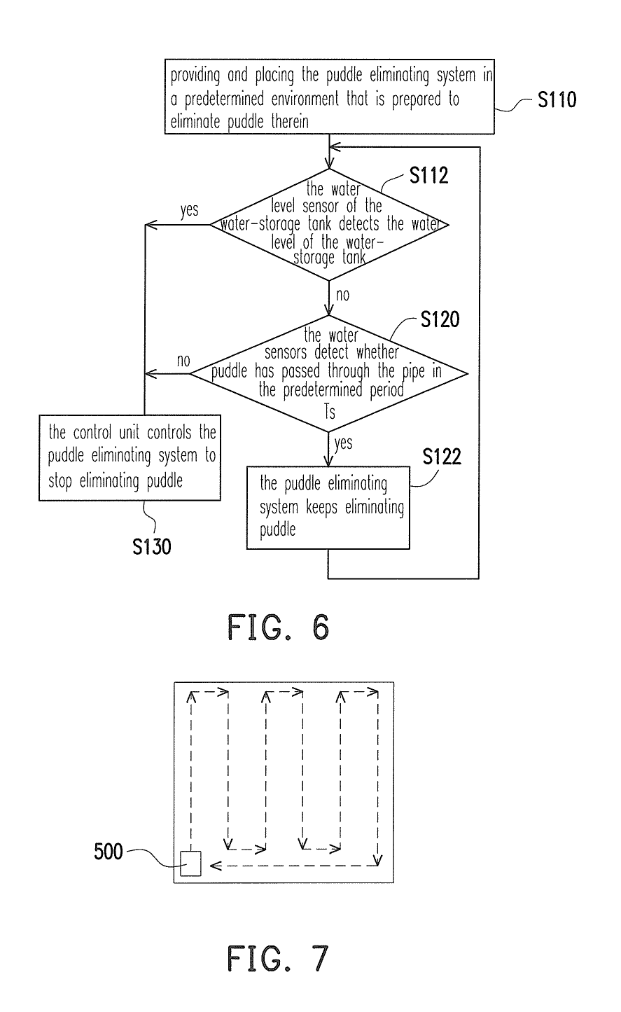

FIG. 6 is a flow chart illustrating a method using the puddle eliminating system in FIG. 5A for eliminating puddle. Referring to FIGS. 5A and 6, the puddle eliminating method of the present invention includes at least the following steps. As step S110, providing the puddle eliminating system 500, and placing the puddle eliminating system 500 in a predetermined environment that is prepared to eliminate puddle therein, so that the puddle eliminating system 500 executes a puddle eliminating mission.

FIG. 7 is a perspective view illustrating the puddle eliminating system and a predetermined shifting path thereof that the puddle eliminating system shifts in the predetermined environment, wherein combinations of dotted lines and arrows represent a predetermined shifting path and directions of the puddle eliminating system 500. With reference to FIG. 7, the path of the puddle eliminating system 500 that shifts in the environment is set by the user for eliminating puddle. In other embodiments, the user does not set the path and the puddle eliminating system 500 shifts around freely and executes the eliminating mission.

Referring to FIGS. 5A and 6, as the following step S120, the water sensors 540 of the puddle eliminating system 500 detect whether the water absorbing unit 530 of the puddle eliminating system 500 absorbs puddle or not. More specifically, the designer can set a predetermined period Ts, the predetermined period Ts may be 5 minutes, 10 minutes, less than 5 minutes or greater than 10 minutes. The predetermined period Ts can be determined by a range of the environment that the puddle eliminating system 500 is placed.

With reference to FIGS. 5A, 5B and 6, in the step S120, the puddle eliminating system 500 shifts in the environment whereat the puddle eliminating system 500 is placed, and the puddle eliminating system 500 trans about due to that the roadblock sensor unit 580 detects the puddle eliminating system 500 meeting roadblocks such as a wall. Meanwhile, the water sensor 540 of the puddle eliminating system 500 continuously detects whether puddle passes through the pipe 532 of the water absorbing unit 530 or not. For detail, the control unit 512 starts the fan unit 560 to operate, thus suction is provided. When there is puddle on the ground or datum plane in the shifting path of the puddle eliminating system 500, puddle will be eliminated into the pipe 532 of the water absorbing unit 530 due to the suction, and the windshield wiper 534 scrapes puddle toward an opening of the pipe 532, so as to gather puddle and clean up the ground or datum plane.

More particularly, before puddle absorbed by the pipe 532 is transferred into the water-storage tank 550, puddle passes through the water sensors 540 disposed in the pipe 532 first. In this embodiment, there is no interface between the first electrode 542 and the second electrode 544 before puddle is absorbed into the pipe 532, here air is omitted, and no electrical connection is formed between the first electrode 542 and the second electrode 544. When puddle passes and is filled with the gap between the first electrode 542 and the second electrode 544, an electrical connection is formed and a resistance value between the first electrode 542 and the second electrode 544 varies. As such, the water sensors 540 detect that puddle is absorbed into the pipe 532 and transfer detecting signals to the control unit 512, and the control unit 512 controls puddle eliminating system 500 to proceed the eliminating mission following the shifting path that is preset.

When the water sensors 540 detect that the water absorbing unit 530 absorbs puddle in a detecting period Tw, wherein the detecting period Tw is less than the predetermined period Ts, the water sensors 540 transfer a keep-eliminating-signal to the control unit 512 of the puddle eliminating system 500, and the puddle eliminating system 500 keeps eliminating puddle as step S122.

Also in the step S120, when the water sensor 540 detect that the water absorbing unit 530 absorbs no puddle in the detecting period Tw, the water sensors 540 transfer a stop-eliminating-signal to the control unit 512. It should be noted that the detecting period Tw is greater than or equal to the predetermined period Ts that is set by the user. Then in the step S130, the control unit 512 controls the puddle eliminating system 500 to stop eliminating puddle.

Subsidiary, between the step S110 and the step S120, the water level sensor 570 of the water-storage tank 550 detects the water level of the water-storage tank 550, as the step S112. If puddle is not full in the water-storage tank 550, the puddle eliminating system 500 goes ahead to the next step to execute the puddle eliminating mission; if puddle is full in the water-storage tank 550, as the step S130, the puddle eliminating system 500 stops the puddle eliminating mission. It has to be mentioned that when the water level sensor 570 detects that puddle in the water-storage tank 550 is full, the signal indicating puddle in the water-storage tank 550 is full is transferred to the control unit 512, and the control unit 512 drives the puddle eliminating system 500 to send out an ala in such that the user can deal with puddle in the water-storage tank 550. The alarm could be a sound sent by a loudspeaker, a light illuminated by a light bulb, or letters displayed by the display panel.

In summary, the puddle eliminating system in this embodiment eliminates puddle effectively. Moreover, the water sensors of the puddle eliminating system detect that whether the puddle eliminating system absorbs puddle or not in a predetermined period, so as to determine the puddle eliminating system to continue or stop the eliminating mission. In contrast to the convention, the puddle eliminating system in the embodiment has an ability of judging the eliminating mission is completed or not, and the eliminating mission could be stopped automatically, therefore the power electricity and the operation time could be saved.

### Second Embodiment

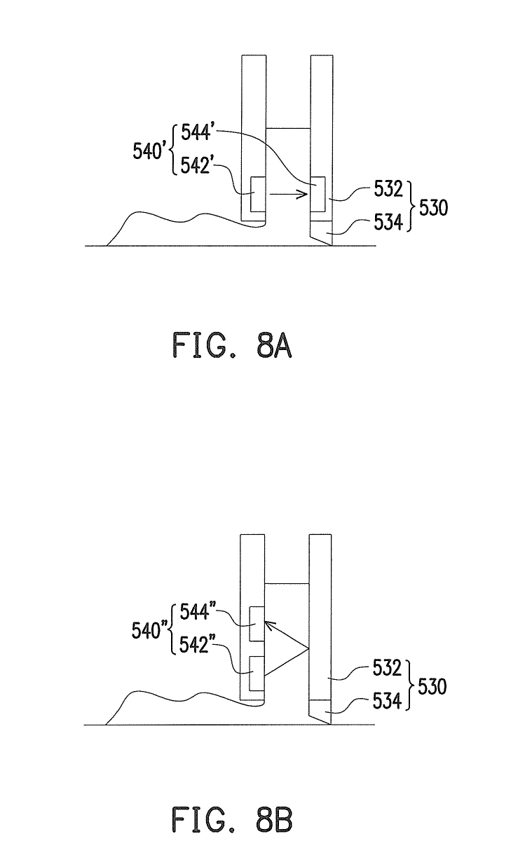

FIG. 8A is a perspective view illustrating the water absorbing unit and the water sensors of the puddle eliminating system of the second embodiment in the present invention. With reference to FIG. 8A, the difference between this embodiment and the first embodiment is as follows: the water sensors 540′ are optical sensors, and each of the water sensors 540′ includes at least one light emitting device 542′ and one light receiving device 544′, and the light emitting device 542′ and light receiving device 544′ are disposed at opposite sides in the pipe 532 of the water absorbing unit 530.

FIG. 8B is a perspective view illustrating another way of disposing the water sensor in the water absorbing unit in FIG. 8A. With reference to FIG. 8B, in another way, the light emitting device 542″ and the light receiving device 544″ are disposed at the same side of the pipe 532 in the water absorbing unit 530, and light emitted from the light emitting device 542″ emits to a wall of the pipe 532 and reflects to the light receiving device 544″.

### Third Embodiment

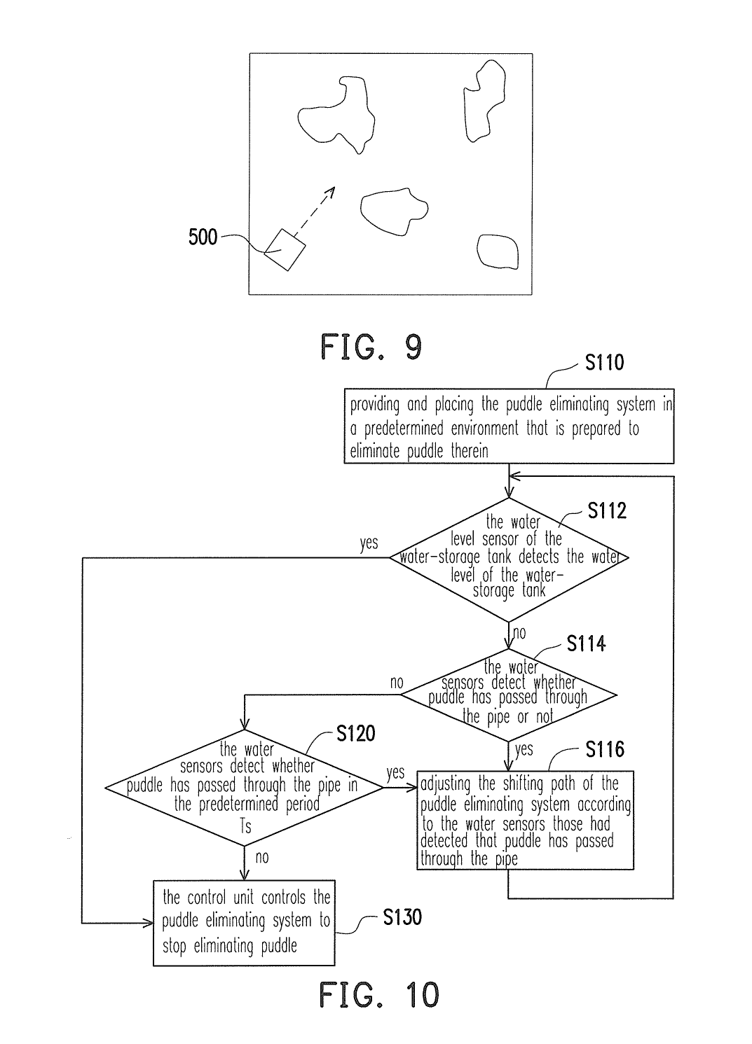

FIG. 9 illustrates the state of puddle on the ground or a datum plane whereat the puddle eliminating system is placed. With reference to FIG. 9, in the environment whereat the puddle eliminating system 500 is placed, puddle is spread around and not uniform.

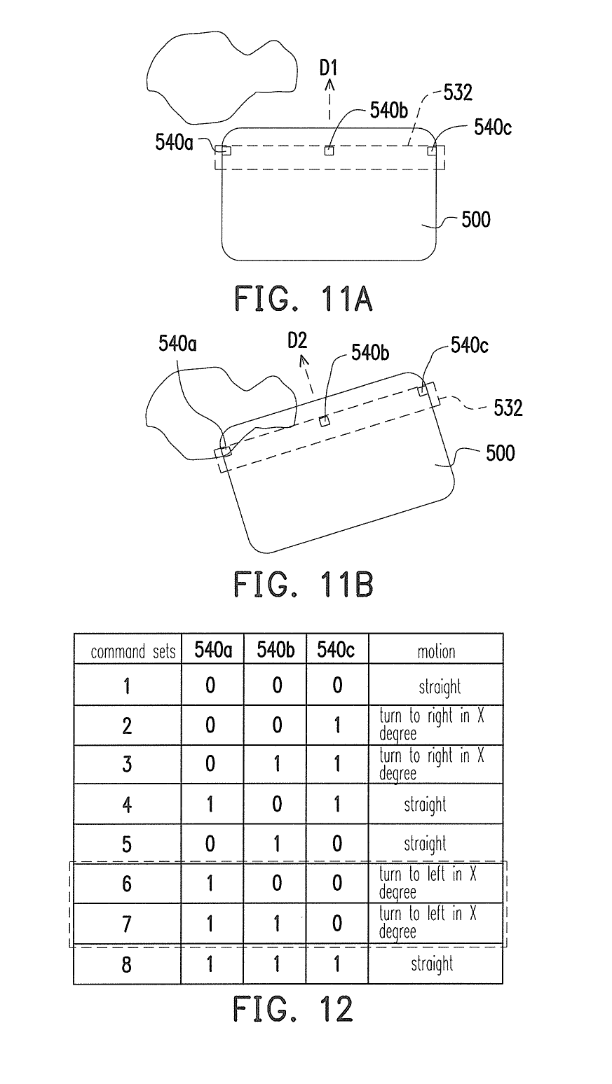

FIG. 10 is a flow chart illustrating another method of using the puddle eliminating system in FIG. 5A for eliminating puddle, and FIGS. 11A and 11B illustrate a shifting path of the puddle eliminating system using the puddle eliminating method. Referring to FIGS. 10, 11A and 11B, the puddle eliminating method in this embodiment and in the first embodiment are approximately the same, but in the puddle eliminating method of the embodiment, between the step S112 and the step S120, the shifting path of the puddle eliminating system 500 is further adjusted according to the water sensors 540 those have detected that the water absorbing unit 530 (shown in FIG. 5A) has absorbed puddle. It is easier to recognize by labeling each of the water sensors 540 into different indicators. In detail, the water sensors 540a and 540c are disposed at left and right sides of the pipe 532 respectively, and the water sensor 540b is disposed between the water sensors 540a and 540c. As shown in FIG. 11A, the puddle eliminating system 500 shifts and executes the eliminating mission along a direction D1. Referring to FIGS. 5A, 10 and 11B, as the step S114, when the water sensor 540a at the left side of the pipe 532 detects puddle has passed through, the water sensor 540a transfers detecting signals to the control unit 512, and the control unit 512 controls the moving wheel set 520 to turn about according to the command sets stored in the control unit 512. And then as the step S116, the puddle eliminating system 500 turns and shifts along a direction D2, wherein the direction D1 and the direction D2 includes an acute angle.

FIG. 12 is a diagram of a command set saved in the control unit. With reference to FIG. 12, “0” presents that neither the water sensors 540a, 540b nor 540c detects puddle has passed through the pipe 532, and “1” presents that the water sensors 540a, 540b or 540c detects puddle has passed through the pipe 532, and the shifting direction of the puddle eliminating system 500 is changed according to the detect results of the water sensors 540a, 540b and 540c. The degree “X” in FIG. 12 can be changed according to the actual requirements of the user. The puddle eliminating system 500 in FIGS. 11A and 11B changes its direction according to the command set 6. Certainly, the actual shifting of the puddle eliminating system 500 corresponding to the command sets 1-8 can be adjusted by the user according to actual requirements.

Thus it can be known that the shifting direction of the puddle eliminating system 500 can be changed according to the water sensors 540a, 540b and 540c of the pipe 532 those have detected that puddle has passed through, therefore puddle can be eliminated effectively, and power electricity and operation time of the puddle eliminating system 500 can be saved.

Referring to FIGS. 10, 11A and 11B, if in the step S114, neither the water sensor 540a, 540b nor 540c detects puddle has passed through the pipe 532, and then the puddle eliminating system 500 keeps shifting, and then as the step S120, keeping counting the detecting period Tw, and detecting whether the water sensors 540a, 540b or 540c has detected puddle having passed through the pipe 532 in the predetermined period Ts. Neither the water sensors 540a, 540b nor 540c detects puddle has passed through the pipe 532 in the detecting period Tw, wherein the detecting period Tw is greater than or equal to the predetermined period Ts, as the step S130, stopping the eliminating mission of the puddle eliminating system 500. If at least one of the water sensors 540a, 540b and 540c detects puddle has passed through the pipe 532 in the predetermined period Ts, and then back to the step S116 to adjust the shifting path of the puddle eliminating system 500.

### Fourth Embodiment

The fourth embodiment is similar to the first embodiment. The same or similar component numbers denote the same or similar components.

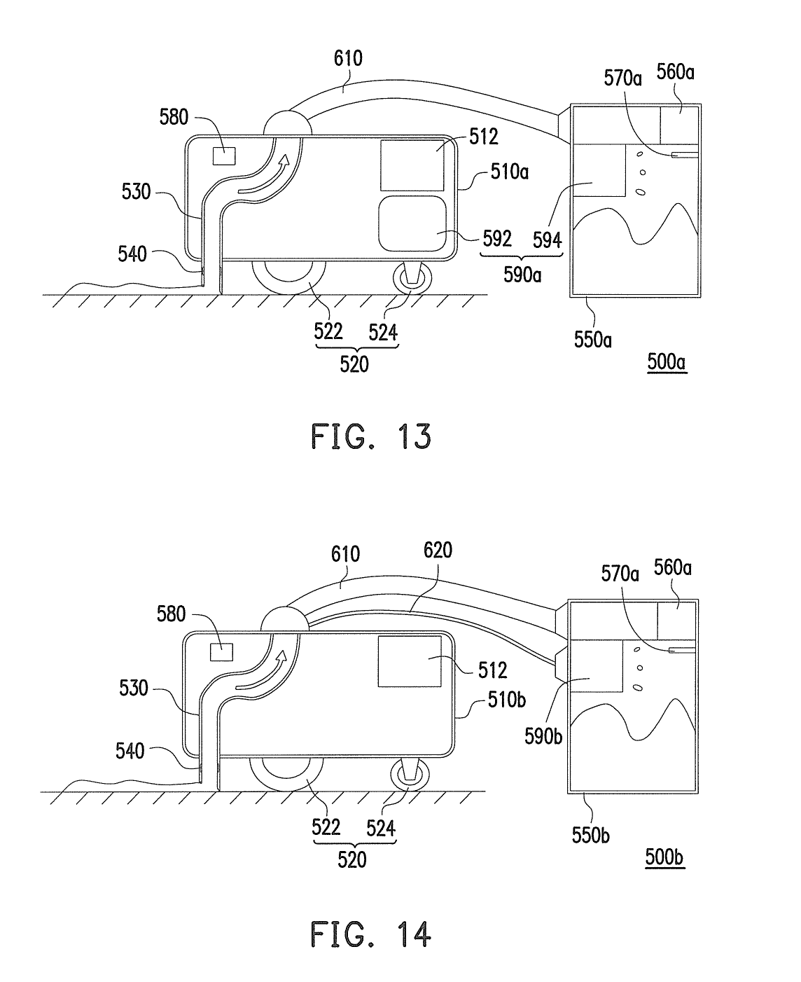

FIG. 13 is a perspective view illustrating the puddle eliminating system of the fourth embodiment in the present invention. With reference to FIG. 13, the difference between the puddle eliminating system 500a of this embodiment and the puddle eliminating system 500 of the first embodiment is as follows: the water-storage tank 550a and the fan unit 560a are all disposed independently out of the main body 510a, and the water absorbing unit 530 communicates to the water-storage tank 550a by a conduit 610. The power supply module 590a includes a first power unit 592 disposed in the main body 510a and a second power unit 594 disposed in the water-storage tank 550a. The first power unit 592 provides power electricity for the control unit 512, the water absorbing unit 530, the water sensors 540, the roadblock sensor unit 580 and the moving wheel set 520, while the second power unit 594 provides power electricity for the fan unit 560 and the water level sensor 570a.

The water-storage tank 550a can be disposed in the environment prepared to be eliminated, and disposing the water-storage tank 550a independently out of the main body 510a, the main body 510a is much light and so as to reduce the load and save the power electricity, and capacity of the water-storage tank 550a can be enlarged such that the puddle eliminating system 500a completes the eliminating mission much accurately.

### Fifth Embodiment

The fifth embodiment is similar to the fourth embodiment. The same or similar component numbers denote the same or similar components.

FIG. 14 is a perspective diagrammatical view illustrating the puddle eliminating system of the fifth embodiment in the present invention. With reference to FIG. 14, the difference between the puddle eliminating system 500b in this embodiment and the puddle eliminating system 500a of the fourth embodiment is as follows: the power supply module 590b is independent out of the main body 510b, such as being disposed in the water-storage tank 550b, and the main body 510b is electrically connected to the power supply module 590b by a power cord 620.

By disposing the power supply module 590b independently out of the main body 510b, the size of the power supply module 590b can be increased, and thus the capacity of power electricity is also increased. As such, the problem that the eliminating system needs to work a long time without enough power electricity can be prevented, thus the puddle eliminating system 500b can work for a long time until the eliminating mission is completed.

To sum up, the puddle eliminating system and puddle eliminating method of the present invention can automatically detect whether puddle is eliminated completely or not. If puddle is eliminated completely, the eliminating puddle mission is stopped automatically. In this way, the idle running of the puddle eliminating system is prevented, and the operation time and power electricity are saved. In addition, the puddle eliminating system can be accomplished by various ways according to actual requirements by the user, and therefore the puddle eliminating system is convenient for using.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A puddle eliminating system, comprising:
a main body, having a control unit;
a moving wheel set, disposed at a bottom of the main body and electrically connected to the control unit;
a water absorbing unit, disposed in the main body and for eliminating puddle in an environment whereat the puddle eliminating system is placed;
at least one water sensor, disposed in the water absorbing unit and electrically connected to the control unit for detecting whether there is puddle passing through the water absorbing unit;
a water-storage tank, communicating with the water absorbing unit for storing the puddle absorbed by the water absorbing unit; and
a fan unit, electrically connected to the control unit,
the control unit driving the moving wheel set to move and controlling the fan unit to provide a suction at the same time, such that the water absorbing unit absorbs and transfers the puddle into the water-storage tank, and the water sensor detects whether there is puddle in the environment whereat the puddle eliminating system is placed in a predetermined period and transfers detecting signals to the control unit.

2. The puddle eliminating system as claimed in claim 1, wherein the moving wheel set is a combination of being selected two from a orientation wheel, a universal wheel, an omnidirectional wheel, a caterpillar band and a chain, and the two are disposed at two opposite sides of the bottom of the main body respectively.

3. The puddle eliminating system as claimed in claim 1, wherein the water absorbing unit includes a pipe connected to the main body and communicated with the water-storage tank.

4. The puddle eliminating system as claimed in claim 3, wherein the water absorbing unit further comprises a windshield wiper, disposed at the back side of the pipe.

5. The puddle eliminating system as claimed in claim 1, wherein the at least one water sensor is a resistiveness sensor or an optical sensor.

6. The puddle eliminating system as claimed in claim 5, wherein the resistiveness sensor includes at least one first electrode and at least one second electrode.

7. The puddle eliminating system as claimed in claim 5, wherein the optical sensor includes at least one light emitting device and at least one light receiving device, and both are disposed in the water absorbing unit.

8. The puddle eliminating system as claimed in claim 7, wherein the light emitting device and the light receiving device are disposed in the water absorbing unit face to face.

9. The puddle eliminating system as claimed in claim 7, wherein the light emitting device and the light receiving device are disposed at the same side in the water absorbing unit.

10. The puddle eliminating system as claimed in claim 1, wherein the water-storage tank is disposed in the main body or independently out of the main body.

11. The puddle eliminating system as claimed in claim 1, wherein the fan unit is disposed in the main body or independently out of the main body.

12. The puddle eliminating system as claimed in claim 1, further comprises a water level sensor, disposed in the water-storage tank for detecting a water level in the water-storage tank.

13. The puddle eliminating system as claimed in claim 1, further comprises a roadblock sensor unit, disposed at the main body for detecting roadblocks when the main body is in a shifting motion process.

14. The puddle eliminating system as claimed in claim 13, wherein the roadblock sensor unit is a ultrared-ray sensor, a ultrasonic sensor, a laser sensor or a combination thereof.

15. The puddle eliminating system as claimed in claim 1, further comprises a power supply module, electrically connected to the control unit of the main body.

16. The puddle eliminating system as claimed in claim 15, wherein the power supply module is disposed in the main body or independently out of the main body.

17. A puddle eliminating method, comprising:
providing a puddle eliminating system, wherein a moving wheel set of the puddle eliminating system bringing the puddle eliminating system to shift in a predetermined environment;
at least one water sensor of the puddle eliminating system detecting whether a water absorbing unit of the puddle eliminating system absorbs puddle or not;
when the at least one water sensor detects the water absorbing unit absorbing puddle, the at least one water sensor transfers a keep-eliminating-signal to a control unit of the puddle eliminating system, and the puddle eliminating system keeps eliminating puddle;
when the at least one water sensor detects the water absorbing unit absorbs no puddle in a detecting period, the at least one water sensor transfers a stop-eliminating-signal to the control unit, and the puddle eliminating system stops eliminating puddle, wherein the detecting period is greater than a predetermined period.

18. The puddle eliminating method as claimed in claim 17, before the at least one water sensor detects whether the water absorbing unit absorbs puddle or not, further comprises making a water level sensor of the puddle eliminating system to detect a water level in a water-storage tank of the puddle eliminating system.

19. The puddle eliminating method as claimed in claim 17, wherein the way that the moving wheel set shifts in a predetermined environment is to shift around freely or in accordance with a predetermined shifting path.

20. The puddle eliminating method as claimed in claim 17, wherein the method that the at least one water sensor detects whether the water absorbing unit absorbs puddle or not is optical sensing or measuring a resistance value.

21. The puddle eliminating method as claimed in claim 17, further comprises adjusting a shifting path of the puddle eliminating system in accordance with the at least one water sensor that has detected that puddle has passed through the water absorbing unit.

22. The puddle eliminating method as claimed in claim 21, wherein the method of adjusting the shifting path of the puddle eliminating system is to save a command set in the control unit, and the control unit reads the command set to adjust the shifting path of the puddle eliminating system.
